(19) United States
(12) Patent Application Publication
(10) Pub. No.: US 2012/0138358 A1
(43) Pub. Date: Jun. 7, 2012

(54) Electrical Fixture Assembly

(76) Inventors: Stuart Dennis McKeith, Middlesex (GB); Lee Royal Robert McKeith, South Yorkshire (GB); Dennis McKeith, Tyne and Wear (GB); Robert McKeith, Tyne and Wear (GB)

(21) Appl. No.: 13/319,183

(22) PCT Filed: May 7, 2010
(86) PCT No.: PCT/GB2010/050744

§ 371 Date: Dec. 23, 2011

(30) Foreign Application Priority Data
May 7, 2009 (GB) 0907770.2

(51) Int. Cl. H02G 3/12

(52) U.S. Cl. 174/502

(57) ABSTRACT

An electrical fixture system includes an electrical fixture assembly and a piercing tool. The electrical fixture assembly includes an outlet junction member for mounting in a wall or a ceiling or a floor, and an electrical fitting. The outlet junction member and the electrical fitting are each provided with at least one mutually compatible electrical connector element. The outlet junction member has a mechanism for connection of the at least one outlet junction member electrical connector element to mains electricity. The piercing tool is removably connectable to the electrical fixture assembly, and the tool is shaped such that it penetrates a wall board pressed against the tool to create an opening in the wall board. The at least one outlet junction member electrical connector element is substantially aligned with the opening in the wall board.

### FIELD OF THE INVENTION

The invention relates to a more advanced and improved electrical fixture assembly, a method for installation of the same, and an electrical tester device for use with the fixture.

### BACKGROUND OF THE INVENTION

In new buildings wall boards are typically fixed to the walls or ceilings prior to plastering. The most commonly used form of wall board is plaster board, but cement board and fibre board are also used.

Interior walls or ceilings are often constructed by securing wall boards to a stud work frame assembled from wooden or sometimes aluminium studs. They can also be constructed by securing wall boards to walls made of bricks or other building blocks. First fix electrical wiring is carried out before the wall boards are secured in place. Because of this, it is necessary to make holes in the wall boards to align with the open outlet boxes mounted by the electricians to receive electrical sockets, light switches and other accessories such as alarms and security cameras.

Typically, such holes are made by measuring and cutting out the holes before offering the wall board to the wall. This is time consuming and can also be inaccurate, leaving larger gaps around electrical boxes which then need to be repaired to give the desired finish to the wall. After the plasterer has plastered the walls the electrician then needs to return to complete the second fix electrics which involves wiring of the electrical wires from the outlet box into the fascia plate which may be a socket, switch, light fitting or other electrical accessory.

U.S. Pat. No. 4,023,697 attempts to mitigate the above mentioned problems by providing an outlet box which includes two spikes for piercing a wall board. When the wall board is offered to the wall these spikes penetrate the wall board giving the plasterer an indication as to the location of the outlet box without measurement. The plasterer must then cut around these spikes to create the hole necessary to access the outlet box and wiring.

There is also a need for an improved method of testing electrical circuits after installation of electrical fixtures. At present electricians need to connect testing equipment up to each socket or switch outlet, often requiring stripping back of the wiring.

It would be desirable to provide an improved electrical fixture device which simplifies the process of installation of electrical devices, along with an improved electrical testing device.

### SUMMARY OF THE INVENTION

One aspect of the invention provides an electrical fixture system comprising
a. an electrical fixture assembly; and
b. a piercing tool;
   the electrical fixture assembly comprises an outlet junction member securable with respect to a surface, and an electrical fitting, wherein the outlet junction member and the electrical fitting are each provided with at least one mutually compatible electrical connector element, the outlet junction member having means for connection of the at least one outlet junction member electrical connector element to mains electricity; and wherein the piercing tool is removably connectable to the electrical fixture assembly and the tool is shaped such that it penetrates a wall board pressed against the tool to create an opening in the wall board that is substantially aligned with the at least one outlet junction member electrical connector element.

The at least one electrical connector element of the outlet junction member protruding from the outlet junction member.

The surface with respect to which the outlet junction member is securable may be a wall or a ceiling or a floor.

The electrical fixture system of the invention allows the easy location of an electrical outlet junction member or outlet box behind a wall board without the need for complex measuring. It also allows an electrical fitting or fascia plate to be directly connected up to an outlet junction member immediately subsequent to fixing of the wall board, without the need to cut a hole in the wall board to expose the outlet junction member. This significantly increases the speed of installation of such electrical fixtures and may not require an electrician to return to site to perform a second fix of electrical work since all of the electrical wiring work is completed in the first step.

The at least one electrical connector element of the outlet junction member preferably protrudes at substantially 90° to the outlet junction member.

Preferably, the removable piercing tool is provided with at least one dummy connector element compatible with the at least one electrical connector element of the outlet junction member. This allows a secure connection between the piercing tool and the outlet junction member.

Preferably, the removable piercing tool is provided with a point, wherein the point is sufficiently sharp to penetrate a wall board. More preferably, the piercing tool is configured to create an opening in the wall board that is shaped so as to receive a part of the electrical fixture assembly, for example a male connector element. Advantageously, the piercing tool includes a portion of a dimension corresponding substantially to the external dimension part of the electrical fixture assembly which is to be received in the opening created.

The electrical fixture assembly may be an electrical socket or a light switch or a light socket or any device requiring an electrical power supply that would otherwise be wired directly into the power supply, for example a fire alarm, an intruder alarm, a cooker, or a shower. The electrical fixture may alternatively be a part of a wired computer or telephone network, for example a telephone jack plug socket, or an ethernet socket.

The electrical fitting may be a socket fascia plate or a switch fascia plate or a light socket or a smoke alarm or an intruder alarm or other electrical or similar fitting, such as a telephone jack plug or ethernet socket.

Advantageously, the electrical fixture system further comprises a removable safety cover so dimensioned as to cover the at least one outlet junction member electrical connector element. Such a safety cover may be fitted to cover the outlet junction member electrical connector element(s) to both protect workmen from a live electrical connection and to protect the outlet junction member electrical connector element(s) from damage. More preferably the safety cover includes an elongate, grippable portion, so that when the safety cover is fitted to the outlet junction member the grippable portion extends from the outlet junction member away from the wall board. This allows easy removal of the safety cover. A safety cover may be fitted to the outlet junction member electrical connector element(s) both before and after the fitting of a wall board is completed.

Preferably, the removable safety cover is provided with at least one dummy connector element compatible with the at least one electrical connector element of the outlet junction member. This allows a secure connection between the safety cover and the outlet junction member. More preferably the at least one electrical connector element of the outlet junction member is a female push-fit connector and the safety cover is provided with at least one male connector element.

According to a further aspect of the invention there is provided an electrical fixture assembly adapted to receive the piercing tool of the electrical fixture system as hereinbefore, the assembly comprising an outlet junction member for mounting in a wall or a ceiling or a floor, and an electrical fitting, wherein the outlet junction member and the electrical fitting are each provided with at least one mutually compatible electrical connector element, the at least one electrical connector element of the outlet junction member protruding from the outlet junction member and the outlet junction member having means for connection of the at least one outlet junction member electrical connector element to mains electricity.

Advantageously, the outlet junction member comprises a back plate and a cover plate and the cover plate includes an elongate collar shaped to cover the at least one outlet junction member electrical connector element.

Preferably, the electrical connector elements are push-fit connector elements. More preferably the electrical connector elements are male/female push-fit connector elements. More preferably the at least one electrical connector element of the outlet junction member is a female push-fit connector and the at least one electrical connector element of the electrical fitting is a male push-fit connector.

The electrical fixture assembly may be an electrical socket or a light switch or a light socket or any device requiring an electrical power supply that would otherwise be wired directly into a power supply, for example a fire alarm, an intruder alarm, a cooker, or a shower.

According to a further aspect of the invention, there is provided an electrical outlet junction member securable with respect to a surface, and which may be for mounting in a wall or ceiling or floor comprising at least one electrical connector element protruding from the outlet junction member, means for connection of the at least one outlet junction member electrical connector element to an electrical circuit, such as a mains electrical circuit, wherein the outlet junction member is adapted to receive a removable piercing tool of the electrical fixture system as hereinbefore defined.

Advantageously, the outlet junction member comprises a back plate and a cover plate and the cover plate includes an elongate collar shaped to cover the at least one outlet junction member electrical connector element.

Preferably, the at least one outlet junction member electrical connector element is a push-fit connector element. More preferably the at least one electrical connector element of the outlet junction member is a female push-fit connector.

According to a further aspect of the invention, there is provided an electrical fitting for an electrical outlet junction member as hereinbefore defined, comprising at least one electrical connector element.

The electrical fitting may be a socket fascia plate or a switch fascia plate or a light socket or a smoke alarm or an intruder alarm or other electrical fitting.

Preferably, the at least one electrical fitting electrical connector element is a push-fit connector element. More preferably the at least one electrical connector element of the electrical fitting is a male push-fit connector.

According to a further aspect of the invention there is provided a piercing tool adapted to releasably connect to the electrical outlet junction member as hereinbefore defined, wherein the tool is shaped such that it penetrates a wall board pressed against the tool to create an opening in the wall board. Advantageously, the piercing tool creates a neat slot in the wall board through which a connector may pass.

Preferably, the removable piercing tool is provided with at least one dummy connector element compatible with the at least one electrical connector element of the outlet junction member. This allows a secure connection between the piercing tool and the outlet junction member.

According to a further aspect of the invention there is provided a safety cover adapted to connect to the electrical outlet junction member as hereinbefore defined, wherein the cover is so dimensioned as to cover the at least one junction member electrical connector element.

According to a further aspect of the invention, there is provided a method for installing an electrical fixture assembly as hereinbefore defined in a wall or stud wall or ceiling or floor comprising the steps of:
i. securing the outlet junction member to a surface;
ii. electrically connecting the at least one outlet junction member electrical connector element to an electrical circuit, such as mains electrical wiring;
iii. fitting the removable piercing tool as hereinbefore defined to the at least one outlet junction member electrical connector element;
iv. offering a wall board to the wall or stud or ceiling or floor; and
v. piercing the wall board with the piercing tool.

The method may include the additional step of
vi. removing the piercing tool to expose the at least one outlet junction member electrical connector element.

The securing of the outlet junction member to the wall (step i.) is not necessarily performed before the wiring up of the at least one outlet junction member electrical connector element (step ii.).

The method may include the further step of performing a test of the electric circuits after step vi.

Preferably, the method further includes the step of connecting the at least one electrical fitting electrical connector element to the at least one outlet junction member electrical connector element after step vi. Preferably this step is completed after the electrical circuits have been tested. Since all the electrical wiring is completed in step ii, the final connection of the electrical fitting may not need to be completed by an electrician, significantly increasing the speed of installation of such electrical fixtures.

Where the outlet junction member comprises a back plate and a cover plate, the back plate is secured to the wall or stud or ceiling or floor.

According to a further aspect of the invention, there is provided an electrical testing device for use with the electrical fixture assembly as hereinbefore defined, the device comprising at least one electrical connection element connectable to the at least one outlet junction member electrical connection element, and means for indicating an electrical connection.

According to a further aspect of the invention, there is provided a light bulb for use with the electrical outlet junction member as hereinbefore defined, the light bulb comprising at least one electrical connection element connectable to the at least one outlet junction member electrical connection element. This has the advantage that a separate fascia plate mounting a connector for receiving a light bulb is not required as the light bulb simply connects directly to the outlet junction member.

The light bulb may be an LED spotlight bulb and the transformer associated with the light bulb may be situated in the electrical outlet junction member.

### BRIEF DESCRIPTION OF THE DRAWINGS

In the drawings, which illustrate preferred embodiments of the invention:

FIG. 1 illustrates a back plate of an electrical fixing assembly according to an embodiment of the invention;

FIGS. 2a and 2b illustrate the wiring box of the back plate of FIG. 1 in more detail;

FIG. 3 illustrates the back plate of FIG. 1 wired to the mains electricity;

FIG. 4a illustrates a cover plate for covering the back plate of FIG. 1;

FIG. 4b illustrates the cover plate of FIG. 4a located over the back plate of FIG. 1;

FIG. 5 illustrates a safety cover;

FIG. 6a illustrates a piercing tool;

FIG. 6b illustrates the piercing tool of FIG. 6a located inside the collar of the cover plate of FIG. 4b;

FIG. 7 illustrates the piercing tool of FIG. 6b protruding through a wall board;

FIG. 8 illustrates the electrical connector elements of the back plate of FIG. 1 visible through the hole in the wall board after removal of the piercing tool of FIG. 6b;

FIG. 9 illustrates a fascia plate electrical fitting for connection with the back plate of FIG. 1;

FIG. 10 illustrates the rear face of the fascia plate of FIG. 9;

FIG. 11 illustrates how the fascia plate of FIG. 9 and the back plate of FIG. 1 connect together through a wall board;

FIG. 12 illustrates an extension piece for the wiring box of the back plate of FIG. 1;

FIG. 13 illustrates an electrical testing devices according to one embodiment of the invention;

FIG. 14 illustrates a light bulb according to an embodiment of the invention;

FIG. 15 illustrates three alternative fascia shapes;

FIG. 16 illustrates an alternative embodiment of an electrical fixing assembly of the invention; and

FIG. 17 illustrates a further alternative embodiment of an electrical fixing assembly of the invention.

### DETAILED DESCRIPTION OF THE PREFERRED EMBODIMENTS

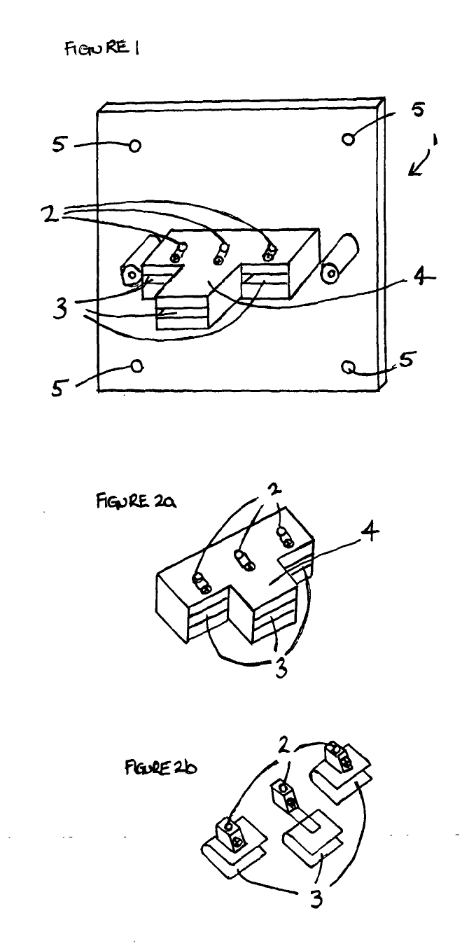

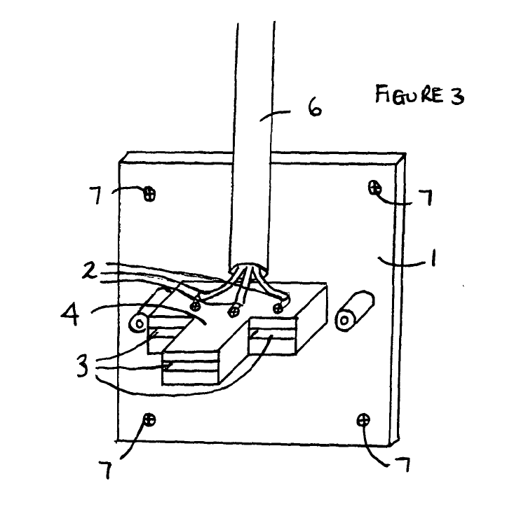

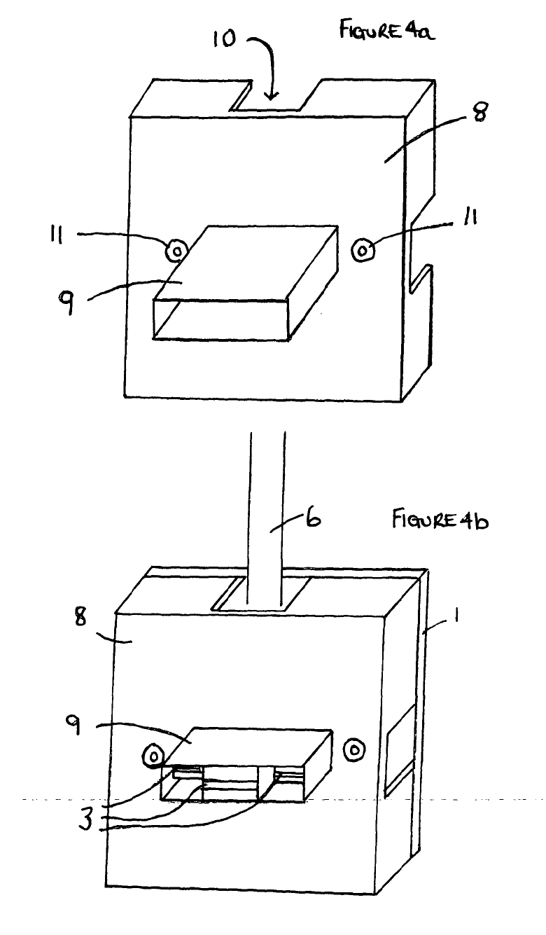

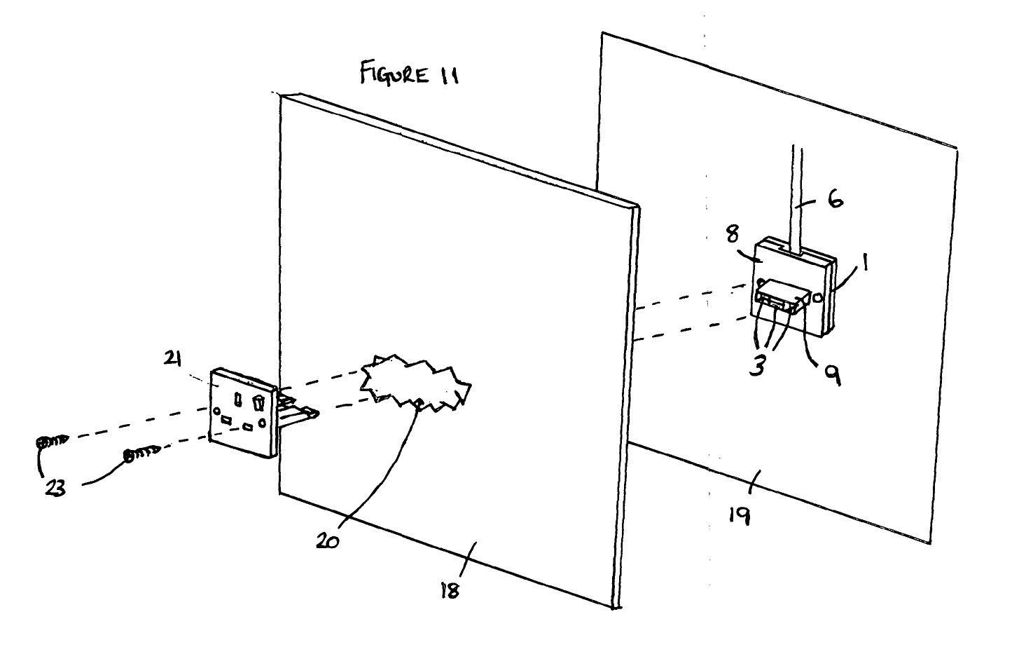

FIG. 1 illustrates a back plate of an electrical outlet junction member or outlet box. The back plate 1 comprises electrical wiring inlets 2 for receiving mains electrical wiring and a wiring box 4, with female electrical connector elements 3 for eventual connection with a fascia plate or other electrical fitting (see 21, FIG. 9). Wiring inlets 2 are in electrical connection with female connectors 3 as shown in FIGS. 2a and 2b. An electrician secures the back plate 1 to the wall or stud where the electrical point is to be located. The back plate 1 may be secured to the wall or stud using screws located through screw holes 5. Once in position the electrician can connect the mains electrical wiring 6 to the wiring inlets 2. FIG. 3 illustrates the back plate 1 secured to a wall using screws 7 with the mains electrical wiring 6 connected to the wiring inlets 2.

FIGS. 2a and 2b illustrate the wiring box 4 in more detail. FIG. 2b illustrates the female electrical connector elements 3 which sit inside the wiring box 4. As shown in FIG. 2b, the female electrical connector elements 3 are connected to electrical wiring inlets 2.

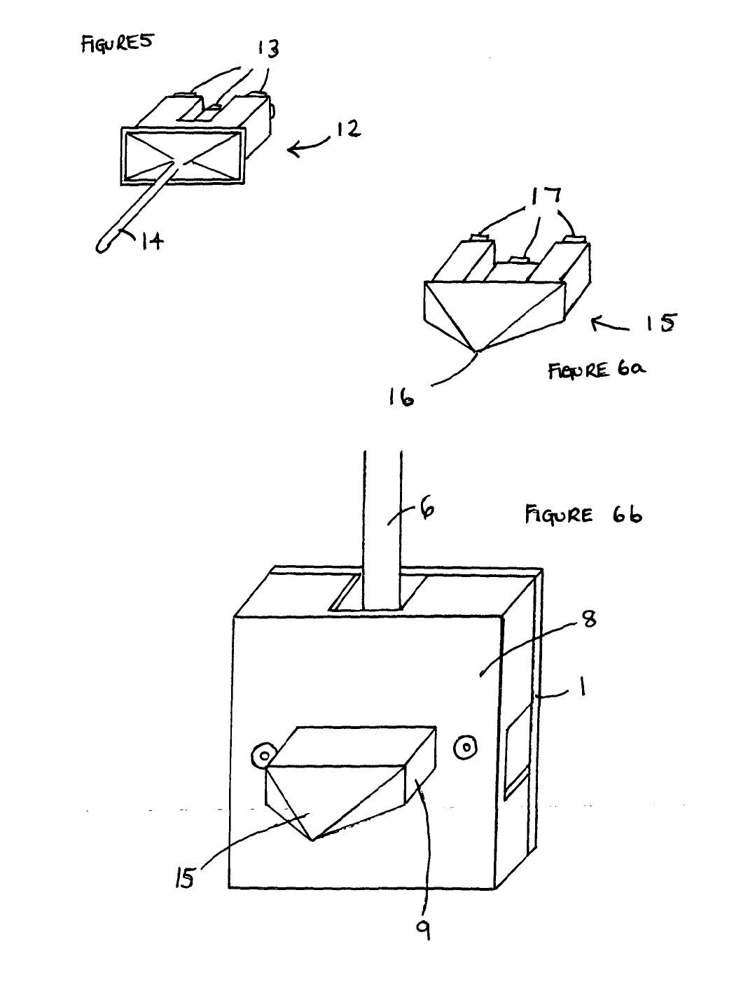

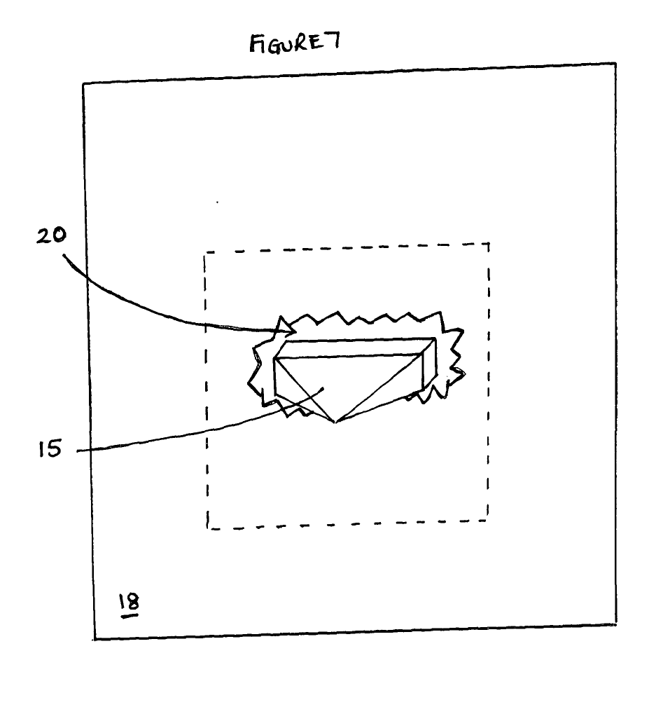

FIG. 4a illustrates a cover plate 8 for placing over the back plate 1. The cover plate 8 and back plate 1 together form the outlet junction member. The cover plate 8 may attach to the back plate 1 via a push-fit system or via screw holes 11. An elongate hollow collar 9 in the front of the cover plate 8 allows access to the female electrical connector elements 3 through the cover plate 8. The length of the elongate collar 9 may be selected or trimmed to size to allow for differences in wall board thickness. There is also a recess 10 in the cover plate to accommodate the mains electrical wiring 6. FIG. 4b illustrates the cover plate 8 in position over the back plate 1, with the female electrical connector elements 3 of the back plate 1 visible through the collar 9 on the cover plate 8. After wiring up the mains electrical wiring 6 to the wiring inlets 2 on the back plate 1 the electrician may install the cover plate 8. The wiring box 4 may also then be protected by covering with a safety cover 12 illustrated in FIG. 5. The safety cover 12 is preferably dimensioned so as to fit inside the collar 9 of the cover plate 8 and preferably has dummy male connector elements 13 which engage with the female electrical connector elements 3 of the back plate. However, the safety cover need not engage with the female electrical connector elements 3. Alternatively, the safety cover 12 may be dimensioned so as to fit over the collar 9 of the cover plate 8 or the wiring box 4. The safety cover 12 preferably also has a flexible, grippable portion such as flexible stem 14 which protrudes away from the back plate to allow easy removal of the cover.

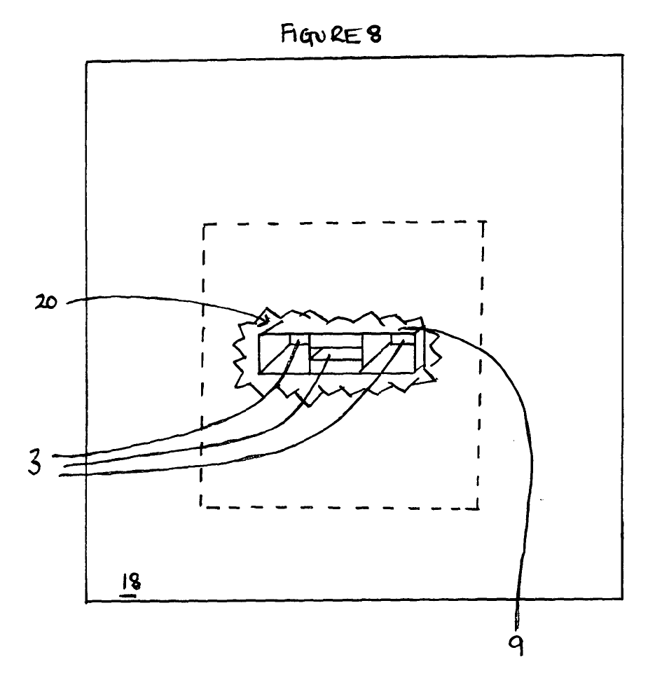

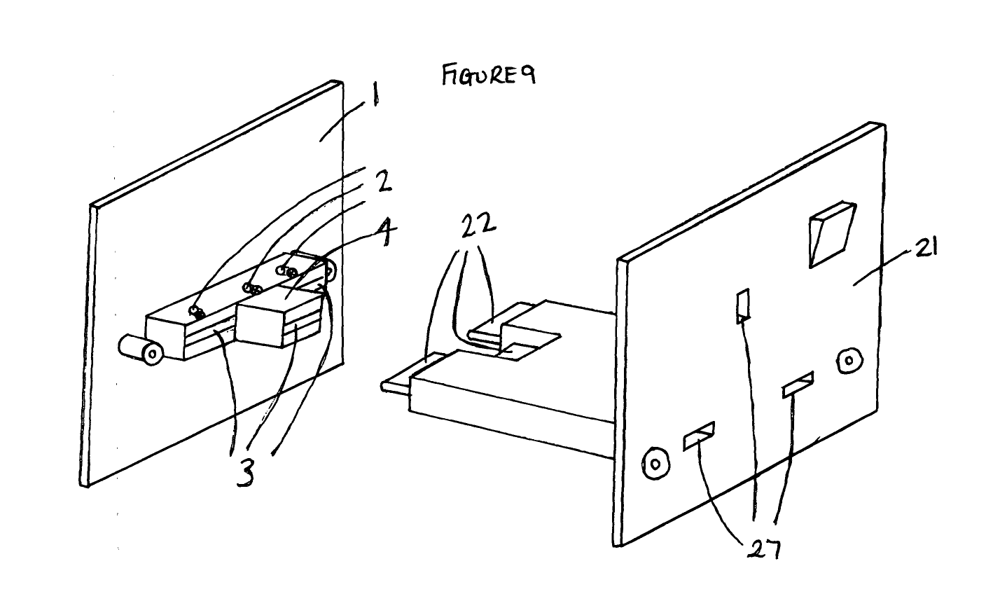

FIG. 6a illustrates a piercing tool 15, preferably shaped so as to fit releasably inside the collar 9 of the cover plate 8. The piercing tool preferably has dummy male connector elements 17 which engage with the female electrical connector elements 3 of the back plate 1, allowing a secure connection between the tool 15 and the back plate 1. However, the piercing tool need not engage with the female electrical connector elements 3. Alternatively, the piercing tool 15 may be dimensioned so as to fit over the collar 9 of the cover plate 8 or the wiring box 4. The piercing tool 15 is pointed at one end 16 to allow it to pierce a wall board. FIG. 6b illustrates the piercing tool 15 fitted inside the collar 9 of the cover plate 8. The piercing tool 15 is fitted to the cover plate 8 prior to fitting of a wall board 18. A wall board 18 is offered to the wall or stud 19 and the tool 15 pierces the board 18, causing the tool 15 to protrude through the wall board 18 as shown in FIG. 7, creating an opening 20 in the wall board 18. The dotted line indicates the outline of the outlet junction member located behind the wall board 18. The tool 15 may now be removed. It may be replaced with a safety cover 12 (see FIG. 5). In the illustrated example, the shape of the piercing tool 15 is such that the opening 20 created in the wall board corresponds substantially to the shape of the collar 9.

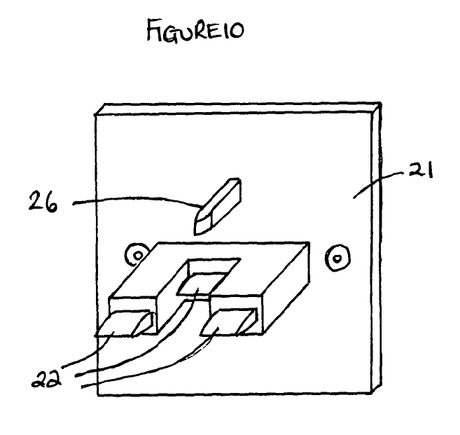

FIG. 8 illustrates the female electrical connector elements 3 visible through the opening 20 in the wall board 18 once the piercing tool 15 has been removed. Preferably the collar 9 of the cover plate 8 emerges through the opening 20 such that it is flush with the front edge of the wall board.

A fascia plate 21 is shown in FIG. 9. In this example the fascia plate 21 is for a single socket plug, but could be any electrical fascia plate such as a double socket, an isolator switch, a light switch or an electrical fitting for a light socket or part a of a device requiring an electrical power supply that would otherwise be wired directly into the power supply, for example a fire alarm, a smoke alarm, an intruder alarm, a cooker, or a shower. The fascia plate 21 is provided with male electrical connector elements 22 which couple to female electrical connector elements 3 on the wiring box 4 of the back plate 1 via a simple push-fit system. Male electrical connector elements 22 on the back of the fascia plate are in electrical connection with the three pins 27 on the front of the fascia plate.

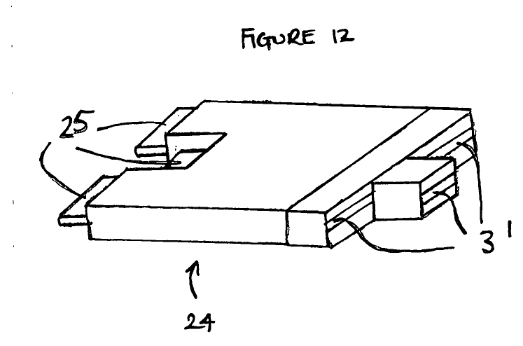

FIG. 10 illustrates the rear side of the 3 pin socket fascia plate 21. In addition to the male electrical connector elements 22 the back of the fascia plate 21 has a hollow member 26 shaped to accommodate the earth pin of a 3 pin plug. The inside of this hollow member 26 is in electrical contact with the middle of the three male electrical connector elements 22.

FIG. 11 illustrates how the fascia plate 21 and the back plate 1 connect together through the wall board 18. The fascia plate 21 may be secured to the cover plate 8 using screws 23 through the wall board 14. There is no need to cut a hole in the wall board to expose the whole of the outlet junction member. This final installation of the fascia plate may not need to be carried out by an electrician since all of the wiring is completed in the first stage of the job.

FIG. 12 illustrates an extension piece 24 which may be used to extend the length of the wiring box 4, and hence the distance of the female connector elements 3 from the back plate 1. This may be necessary when using thick wall boards. The extension piece 24 has male electrical connector elements 25 at one end for engagement with the female electrical connector elements 3 of the back plate, and female electrical connector elements 3′ for eventual connection with a fascia plate at the other end.

Whilst the example illustrated incorporates female connectors on the back plate and male connectors in the fascia plate it is appreciated that any combination of male and female connectors could be used to equal effect.

FIG. 13 illustrates an electrical testing device for use with the electrical fixture hereinbefore described. The testing device 200 has male electrical connector elements 201 which connect to female electrical connector elements 3 on an outlet junction member of an electrical fixture (not shown). In order to test a plug socket the electrician will simply insert the testing device 200 into the female connectors on the socket outlet junction member. A reading on the screen 202 will indicate a complete circuit.

In order to test a lighting circuit the electrician will require two devices 200. The first testing device 200 is inserted into the female electrical connector elements on the light switch fixture and a second testing device 200 is inserted into the female electrical connector elements on the light socket fixture. One device is set to ‘send’ and the other is set to ‘receive’. A reading on the screen 202 will indicate a complete circuit.

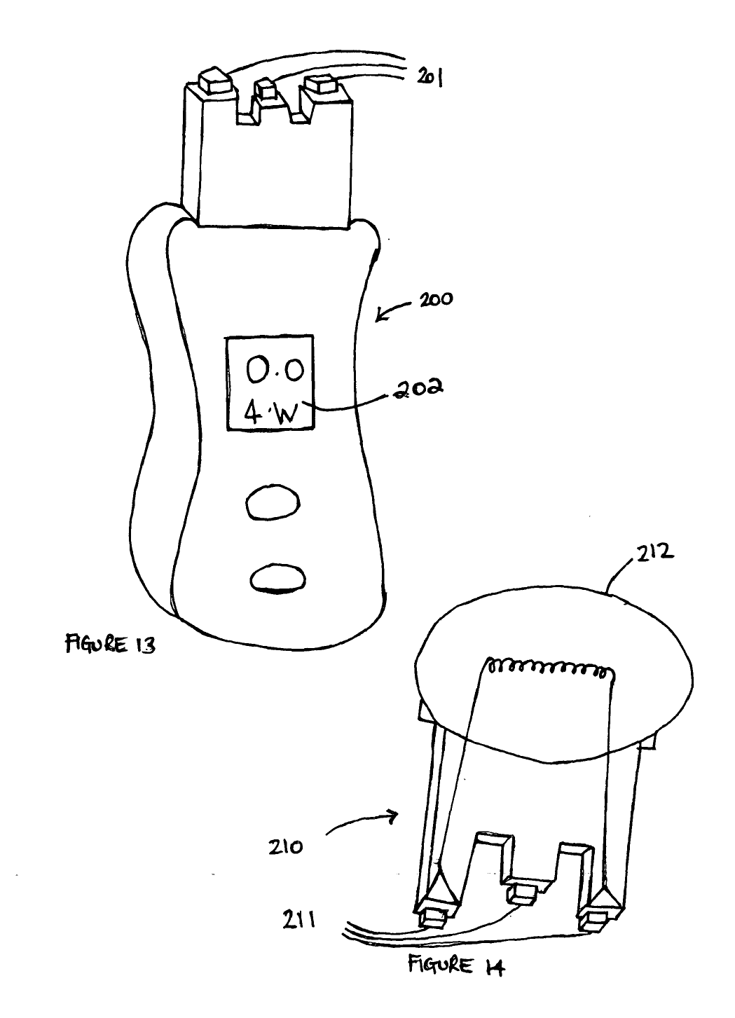

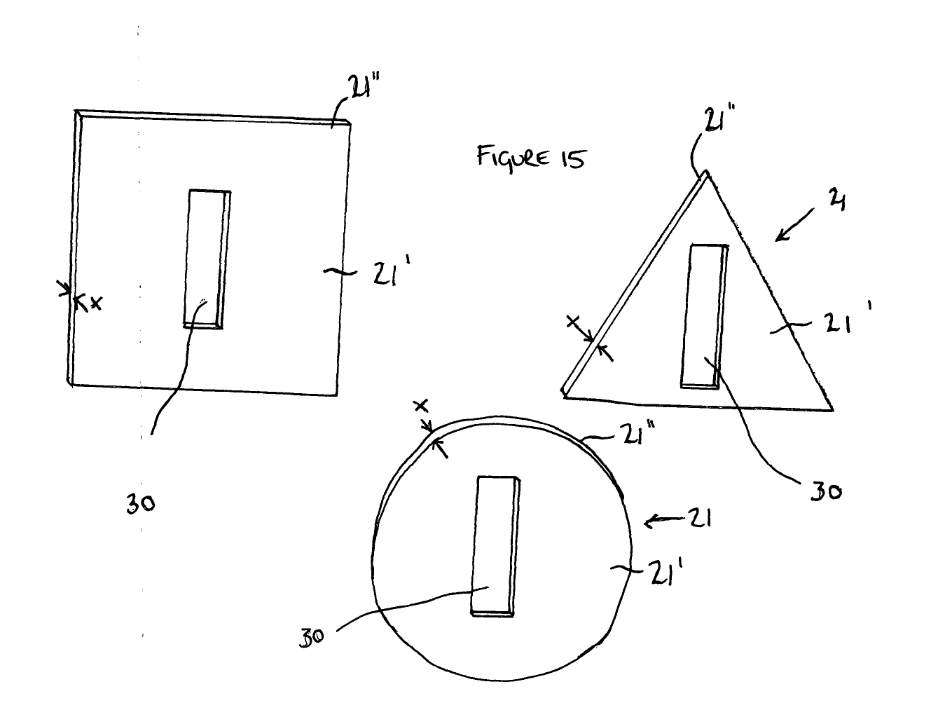

FIG. 14 illustrates an LED spotlight light bulb 210. The light bulb 210 has male electrical connector elements 211 which connect directly to female electrical connector elements 3 on an electrical outlet junction member (not shown) without the need for a fascia plate. The transformer required by the LED spotlight light bulb may be housed in the outlet junction member, removing the need for a bulky fascia plate.

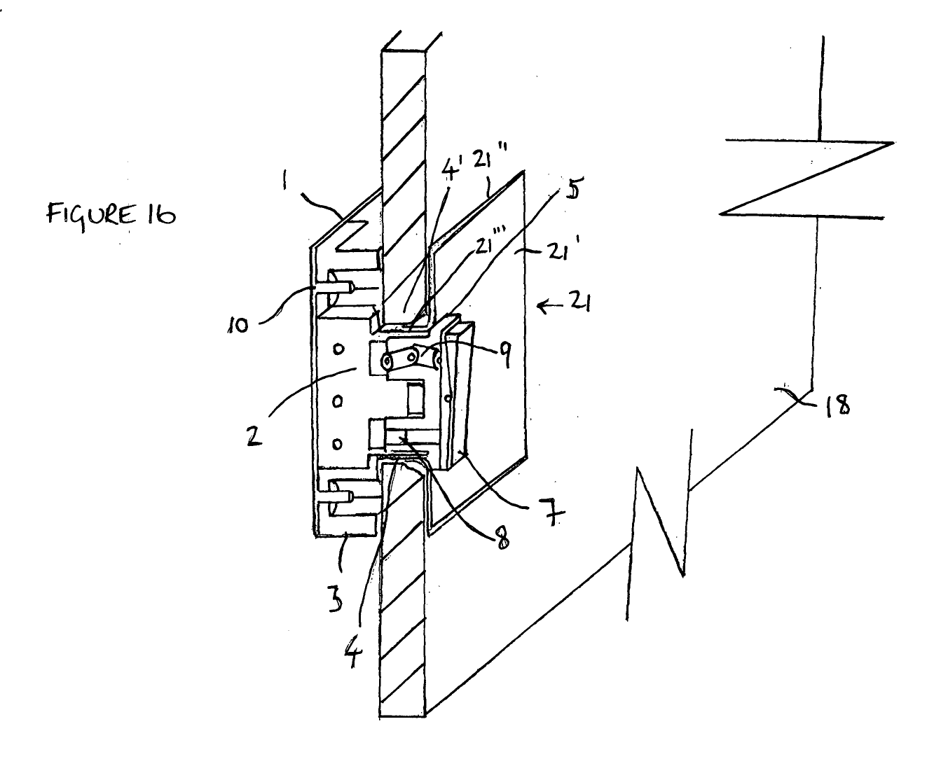

Referring now to FIGS. 15 to 17, in these embodiments the fascia plate 21 is particularly thin. The small thickness of the fascia plate is particularly desirable to designers of lighting equipment, since to date they have not enjoyed the freedom to use a fascia plate of such small thickness that it sits almost flush with the wall in which the switch is mounted. As can be seen from FIG. 15, the fascia plate 21 may be of any desirable shape. Further, fascia plates 21 may comprise two plates 21′ and 21″ spaced apart by a small distance “x”. Advantageously, the plates 21′, 21″ are sealed along three edges, thereby forming a pocket into which a card bearing a particular design and/or advertising. For example, a designer may create an artwork on the card or the card may bear a logo. The operator of a building may therefore use electrical fittings to convey advertising messages, thereby creating a potential revenue stream, in sales of advertising space that would not be available without the present invention. The distance “x” is preferably sufficiently small that the card is a push fit in the pocket. The card may be formed of any suitably stiff material, such as cardboard or plastics.

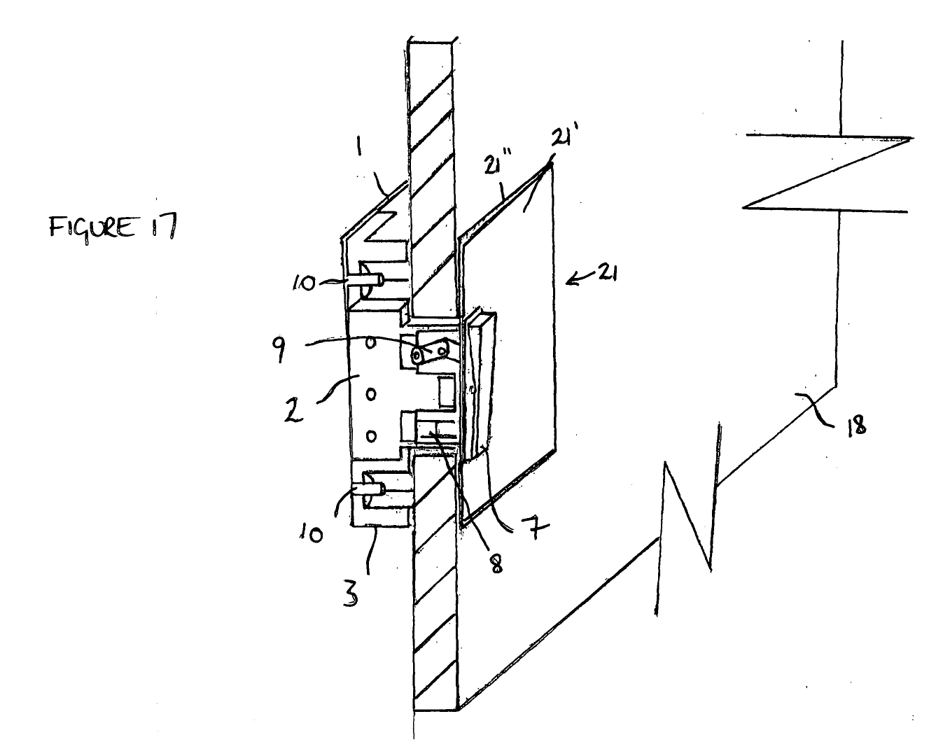

Each fascia 21 includes an opening 30, through which a connector 5 may be passed as illustrated in FIGS. 16 and 17, described in greater detail below.

Referring first to FIG. 16, there is shown an electrical fixing assembly comprising a back plate 1, and a female connector 2 situated between the back plate 1 and a safety cover 3. Locating pins 10 determine the position of the safety cover 3 with respect to the back plate 1. The safety cover 3 includes a collar 4, having serrated surfaces 4′. The plate 21″ of the fascia 21 includes collar 21″′ which pushes over and clicks on to the serrated collar 4. A male connector 5 is then pushed into the female connector 2 through the opening 30 in the fascia 21. In the example illustrated in FIG. 16, the male connector 5 includes a switch 7, which operates an on/off electrical contact 8, using an over-centre lever mechanism 9. As can be seen from FIG. 16, the fascia lies substantially flush with the wall board 18.

The embodiment illustrated in FIG. 17 is similar to that illustrated in FIG. 16, but the collar 4 does not include a serrated surface. The fascia 21 is attached to the assembly by means of a groove located about the perimeter of the on/off switch 7, the plates 21′, 21″ locating in the groove. To assemble the parts of the fixing illustrated in FIG. 17, the male connector 5 is inserted into the opening 30 in the fascia plate and is pushed home until the perimeter of the opening sits in a groove in the outer wall of the male connector 5.

Advantageously, a gasket is provided between the surface of the fascia 21 facing the wall board and the wall board or any plaster which may have been applied to the wall board, the gasket preventing damage by chemical reaction between the wall board or plaster and the material of the fascia 21.

The fascia 21 may be very thin, for example as thin 32 thousand's of an inch, thereby allowing the fascia 21 to lie substantially flush with the wall board. Whilst the fascia 21 formed of two spaced apart plates 21′ and 21″ provides the advantage of a pocket into which a card or other media carrying element may be inserted, the fascia 21 may include only one plate. Again, this may be of 32 thousand's of an inch in width. It is the very nature of the electrical fixture system of the invention that allows such a thin fascia to be deployed.

The invention is described with reference to mains wiring. Such wiring may be of any voltage/current combination depending on the application or relevant standards. Further, the invention is equally applicable to other wired devices, such as telephone wiring and the attachment of connection points, computer networking, etc.

1-35. (canceled)

36. An electrical fixture system comprising:
an electrical fixture assembly; and
a piercing tool;
the electrical fixture assembly comprising an outlet junction member securable with respect to a surface, and an electrical fitting, wherein the outlet junction member and the electrical fitting are each provided with at least one mutually compatible electrical connector element, the outlet junction member having means for connection of the at least one outlet junction member electrical connector element to an electrical circuit; and wherein the piercing tool is removably connectable to the electrical fixture assembly and the tool is shaped such that it penetrates a wall board pressed against the tool to create an opening in the wall board that is substantially aligned with and the at least one outlet junction member electrical connector element.

37. An electrical fixture system according to claim 36, wherein the at least one electrical connector element of the outlet junction member protrudes from the outlet junction member.

38. An electrical fixture system according to claim 36, wherein the piercing tool is provided with at least one dummy connector element compatible with the at least one electrical connector element of the outlet junction member.

39. An electrical fixture system according to claim 36, wherein the removable piercing tool is provided with a point and the point is sufficiently sharp to penetrate a wall board.

40. An electrical fixture system according to claim 36, wherein the electrical fixture assembly is one of an electrical socket, a light switch, and a light socket.

41. An electrical fixture system according to claim 36, wherein the at least one electrical connector element of the outlet junction member protrudes at substantially 90° to the outlet junction member.

42. An electrical fixture system according to claim 36, further comprising a removable safety cover so dimensioned as to cover the at least one outlet junction member electrical connector element.

43. An electrical fixture system according to claim 36, wherein the electrical fitting is one of a socket, a switch, a light socket, and a smoke alarm.

44. An electrical fixture system according to claim 36, further comprising a fascia plate.

45. An electrical fixture system according to claim 44, wherein at least a part of one surface of the fascia is at least partial transparent, the fascia including a pocket adapted to receive a display piece.

46. An electrical fixture system according to claim 44, wherein a switch is an integral part of the fascia plate.

47. An electrical fixture assembly adapted to receive the piercing tool of the electrical fixture system as defined in claim 36, the assembly comprising an outlet junction member for mounting in one of a wall, a ceiling, and a floor, and an electrical fitting, wherein the outlet junction member and the electrical fitting are each provided with at least one mutually compatible electrical connector element, the at least one electrical connector element of the outlet junction member protruding from the outlet junction member and the outlet junction member having means for connection of the at least one outlet junction member electrical connector element to mains electricity.

48. An electrical fixture assembly according to claim 47, wherein the outlet junction member comprises a back plate and a cover plate and the cover plate includes an elongate collar shaped to cover the at least one outlet junction member electrical connector element.

49. An electrical fixture assembly according to claim 47, wherein the electrical connector elements are push-fit connector elements.

50. An electrical fixture assembly according to claim 49, wherein the at least one electrical connector element of the outlet junction member is a female push-fit connector and the at least one electrical connector element of the electrical fitting is a male push-fit connector.

51. An electrical outlet junction member for mounting in one of a wall, a ceiling, and a floor comprising at least one electrical connector element protruding from the outlet junction member, means for connection of the at least one outlet junction member electrical connector element to mains electricity, wherein the outlet junction member is adapted to receive a removable piercing tool of the electrical fixture system as defined in claim 36.

52. An electrical outlet junction member according to claim 51, wherein the outlet junction member comprises a back plate and a cover plate and the cover plate includes an elongate collar shaped to substantially align with the at least one outlet junction member electrical connector element.

53. An electrical outlet junction member according to claim 51, wherein the at least one electrical connector element is a push-fit connector element.

54. An electrical outlet junction member according to claim 53, wherein the at least one electrical connector element is a female push-fit connector element.

55. A piercing tool adapted to connect to the electrical outlet junction member as defined in claim 51, wherein the tool is shaped such that it penetrates a wall board pressed against the tool to create an opening in the wall board.

56. A piercing tool according to claim 55, wherein the tool is provided with at least one dummy connector element compatible with the at least one electrical connector element of the outlet junction member.
